(19) United States
(12) Patent Application Publication
(10) Pub. No.: US 2026/0093263 A1
(43) Pub. Date: Apr. 2, 2026

(54) CONTROL METHOD AND CONTROL DEVICE FOR SMART FACTORY

(71) Applicants: Hyundai Motor Company, Seoul (KR); Kia Corporation, Seoul (KR)

(72) Inventors: Kyung Dong Park, Hwaseong, Gyeonggi-do (KR); Sang Won Yoon, Hwaseong, Gyeonggi-do (KR); Man Ki Lee, Hwaseong, Gyeonggi-do (KR); Kye Un Ahn, Hwaseong, Gyeonggi-do (KR)

(21) Appl. No.: 19/111,137

(22) PCT Filed: Dec. 20, 2022
(86) PCT No.: PCT/KR2022/020796

§ 371 Date: Mar. 12, 2025

(30) Foreign Application Priority Data
Oct. 18, 2022 (KR) 10-2022-0134239

(51) Int. Cl. G05D 1/644; G05B 19/418; G05D 107/70; G06Q 10/0631

(52) U.S. Cl. CPC G05D 1/644; G05B 19/41895; G06Q 10/06311; G05B 2219/50393; G05D 2107/70

(57) ABSTRACT

Disclosed are a control method and a control device for a smart factory, the method comprising the steps of: determining and outputting a movement route of a smart logistics vehicle; checking the location of the smart logistics vehicle, and outputting a first control signal corresponding to the location; and checking the interlock state while the smart logistics vehicle is moving, and outputting or postponing, on the basis of the interlock state, a second control signal for stopping the smart logistics vehicle.

### TECHNICAL FIELD

The present disclosure relates to a control method and a control device for a smart factory capable of efficiently managing processes of the smart factory.

### BACKGROUND ART

In recent years, smart logistics vehicles have been introduced not only in general logistics warehouses and factories, but also in smart factories that manufacture products with different specifications using various parts.

Smart logistics vehicles are generally referred to as autonomous mobile robots (AMRs), automated guided vehicles (AGVs), and unmanned forklifts, and these smart logistics vehicles can move and work under the control of a control system. In addition, the control system can control not only smart logistics vehicles but also the operations of production equipment.

When such smart logistics vehicles and control systems are applied, it is possible to flexibly and efficiently handle the supply and transfer of parts and the like.

However, there are cases where the process is delayed depending on the control system's control processing of smart logistics vehicles, so it is necessary to propose a method to improve process efficiency through rapid control processing.

The matters described above as the background technology are only intended to enhance the understanding of the background of the present disclosure, and should not be accepted as acknowledging that it corresponds to the prior art already known to those skilled in the art.

### DISCLOSURE

### Technical Problem

An objective of the present disclosure is to provide a control method and a control device for a smart factory, which are capable of efficiently controlling a smart logistics vehicle.

The technical tasks to be achieved by the present disclosure are not limited to the technical task mentioned above, and other technical tasks not mentioned may be clearly understood by those skilled in the art from the following description.

### Technical Solution

A control method of a smart factory according to an exemplary embodiment of the present disclosure for realizing the tasks described above includes a step of determining a movement route of a smart logistics vehicle destined for a specific area on the basis of an inputted production information and outputting the determined movement route, a step of identifying a location of the smart logistics vehicle travelling along the movement route and outputting a first control signal corresponding to the identified location of the smart logistics vehicle to a process controller corresponding to the specific area, and a step of identifying an interlock state corresponding to an entry requirement of the specific area from the process controller on the basis of the outputted first control signal during the movement of the smart logistics vehicle and outputting or holding a second control signal which enables stopping the smart logistics vehicle on the basis of the interlock state.

A control device of a smart factory according to an exemplary embodiment of the present disclosure for realizing the tasks described above includes a communication unit for communicating with at least one process controller, and a task schedule management unit for controlling the communication unit, determining a movement route of a smart logistics vehicle destined for a specific area on the basis of an inputted production information and outputting the determined movement route, identifying a location of the smart logistics vehicle travelling along the movement route, and outputting a first control signal corresponding to the identified location of the smart logistics vehicle to a process controller corresponding to the specific area, wherein the task schedule management unit identifies an interlock state corresponding to an entry requirement of the specific area from the process controller on the basis of the outputted first control signal during the movement of the smart logistics vehicle and outputs or holds a second control signal which enables stopping the smart logistics vehicle on the basis of the interlock state.

### Advantageous Effects

By various exemplary embodiments of the present disclosure as described above, it may be possible to reduce process delays that occur when a smart logistics vehicle enters a process, by controlling the process on the basis of a location of the smart logistics vehicle without separate control intervention while the smart logistics vehicle is travelling.

Through this, it may be possible to increase a control convenience of a smart factory and improve process efficiency and productivity.

The effects obtained from the present disclosure are not limited to the effects mentioned above, and other effects not mentioned may be clearly understood by those skilled in the art to which the present disclosure belongs from the description below.

### DESCRIPTION OF DRAWINGS

FIG. 1 is a block diagram showing an example of a smart factory configuration applicable to exemplary embodiments of the present disclosure.

FIG. 2 is a block diagram showing an example of a control device configuration applicable to exemplary embodiments of the present disclosure.

FIG. 3 is a block diagram showing an example of a smart logistics vehicle configuration applicable to exemplary embodiments of the present disclosure.

FIG. 4 is a perspective view showing an example of a smart logistics vehicle exterior applicable to exemplary embodiments of the present disclosure.

FIG. 5 is a flowchart showing an example of a driving process of smart logistics vehicle applicable to exemplary embodiments of the present disclosure.

FIG. 6 is a view for explaining an operation of a control device according to an exemplary embodiment of the present disclosure.

FIG. 7 is a view for explaining a control process according to an exemplary embodiment of the present disclosure.

### MODE FOR INVENTION

Hereinafter, exemplary embodiments disclosed in the present specification will be described in detail with reference to the accompanying drawings, but identical or similar components will be assigned with the same reference numbers regardless of the reference numerals, and redundant descriptions thereof will be omitted. The suffixes “module” and “unit” to components used in the following description are assigned or used interchangeably only for the convenience of writing the specification, and do not have distinct meanings or roles by themselves. In addition, in describing the exemplary embodiments disclosed in the present specification, the detailed description thereof will be omitted when it is determined that a detailed description of the related known technology may obscure the gist of the exemplary embodiments disclosed in the present specification. In addition, the accompanying drawings are only intended to facilitate easy understanding of the exemplary embodiments disclosed in the present specification, and the technical ideas disclosed in the present specification are not limited by the accompanying drawings, and should be understood to include all modifications, equivalents, or substitutes included in the spirit and technical scope of the present disclosure.

Terms including ordinal numbers, such as a first and a second, may be used to describe various components, but the components are not limited by the above terms. The terms are used only for the purpose of distinguishing one component from another component.

When it is mentioned that a component is “connected” or “linked” to another component, it should be understood that it may be directly connected or linked to that other component, but there may be other components in between. On the other hand, when it is mentioned that a component is “directly connected” or “directly linked” to another component, it should be understood that no other component exists in the middle.

Singular expressions include plural expressions unless the context clearly indicates otherwise.

In the present specification, terms such as “include” or “have” are intended to specify the existence of features, numbers, steps, operations, components, parts, or combinations thereof described in the specification, and should be understood not to preclude the existence or addition of one or more other features, numbers, steps, operations, components, parts, or combinations thereof.

In addition, a unit or a control unit included in the internal configuration name of a smart logistics vehicle or control device is a term widely used to name a control device that controls a specific function, but does not mean a generic function unit. For example, each control device may include a modem/transceiver for communicating with other control devices or sensors to control the function it is in charge of, a memory for storing operating system or logic commands and input/output information, and one or more processors for performing determination, calculation, and decision necessary for controlling the function it is in charge of. Depending on implementation, one processor may be responsible for calculations for a plurality of control devices.

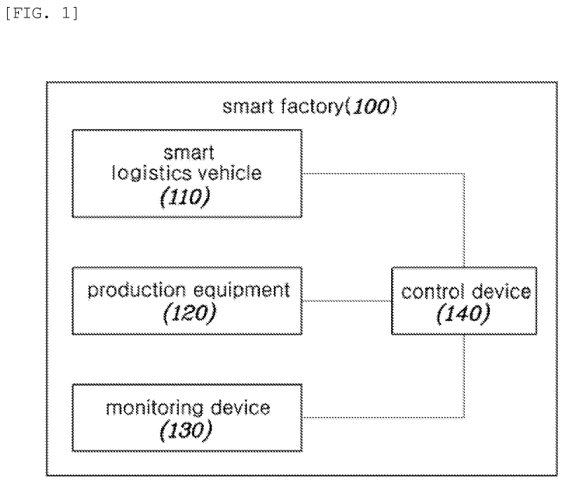

First, a configuration of a smart factory where a smart logistics vehicle according to an exemplary embodiment is disposed and operated will be described with reference to FIG. 1.

FIG. 1 is a block diagram showing an example of a smart factory configuration applicable to exemplary embodiments of the present disclosure.

Referring to FIG. 1, a smart factory 100 may include a smart logistics vehicle 110, a production equipment 120, a monitoring device 130, and a control device 140.

The smart factory 100 may be provided with a plurality of smart logistics vehicles 110, a plurality of production equipment 120, and a plurality of monitoring devices 130 depending on a production process and a target production speed of a product. Hereinafter, each component will be described.

First, the smart logistics vehicle 110 may include an autonomous mobile robot (hereinafter, referred to as an “AMR” for convenience), an automated guided vehicle (hereinafter, referred to as an “AGV” for convenience), and an unmanned forklift. Only one type of the AGVs or AMRs may be operated in the smart factory 100 according to an operation policy of the smart logistics vehicle 110, or AGV and AMR may be operated together within a single smart factory 100.

AGVs generally may perform the operations (moving, turning, stopping, etc.) required within the smart factory 100 by recognizing and following the guide facility disposed on the floor for the guide of AGV. Herein, the guide facility may refer to optically recognizable markers (spots, 2D codes, etc.), tags that can be recognized in a close range without contact (e.g., NFC tags, RFID tags, etc.), magnetic strips, wires, etc., but this may be only an example and may be not necessarily limited thereto. The guide facility may be disposed continuously on the floor or discontinuously disposed to be spaced apart from each other. Since basically performing operations through recognizing and following the guide facility, the AGV may require the guide facility to be installed in advance before operations, such that when the AGV needs to move to a new route or an existing route needs to be modified, the installation or modification of the guide facility needs to be done physically. In addition, since the AGV does not deviate from the route set by the guide facility, it may be common for the AGV to stop until the detected obstacle disappears or a separate control is received when an obstacle is detected on or near the route. In the operation of the AGV, the control device 140 should control the AGV on the basis of the guide facility, so commands such as “drive from the current location until the third marker is recognized” and “switch the heading direction by 90 degrees when the third marker is recognized” and the like may be transmitted to the AGV as individual command units or mission units (e.g., retrieve, supply, charge, patrol, etc.) including a plurality of commands.

The AMR may determine the current location (i.e., localization) by sensing its surroundings, and may be capable of its own path planning by using localization and a map, which is what most distinguishes it from an AGV. Therefore, when a map with coordinates compatible with the AMR and the control device 140 is shared, the control device 140 may control the AMR in a manner of instructing the AMR to take a route based on coordinates. In addition, when an obstacle is detected while travelling, the AMR may avoid the obstacle by setting its own avoidance route and then return to the original route. A function of the control device 140 to set a route of AMR by using one or more transit coordinates may be referred to as global path planning, and a function of the AMR to set a movement route or an avoidance route between transit coordinates according to the global path planning may be referred to as local path planning.

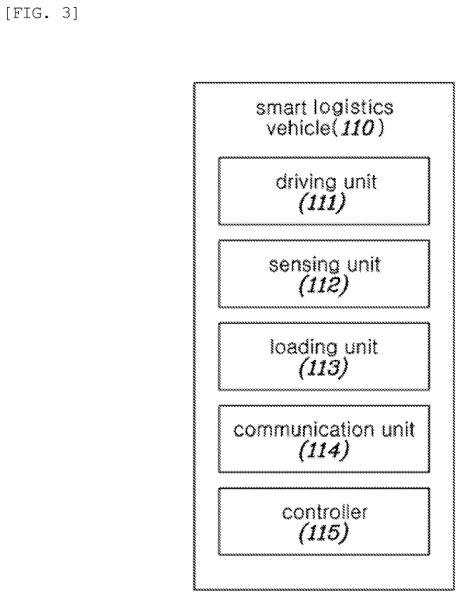

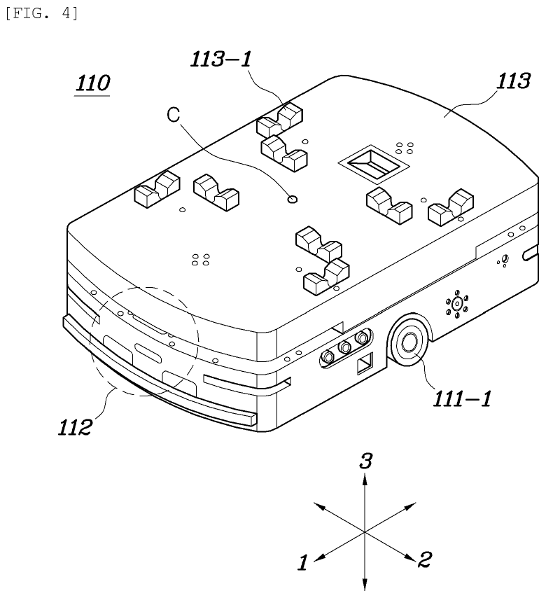

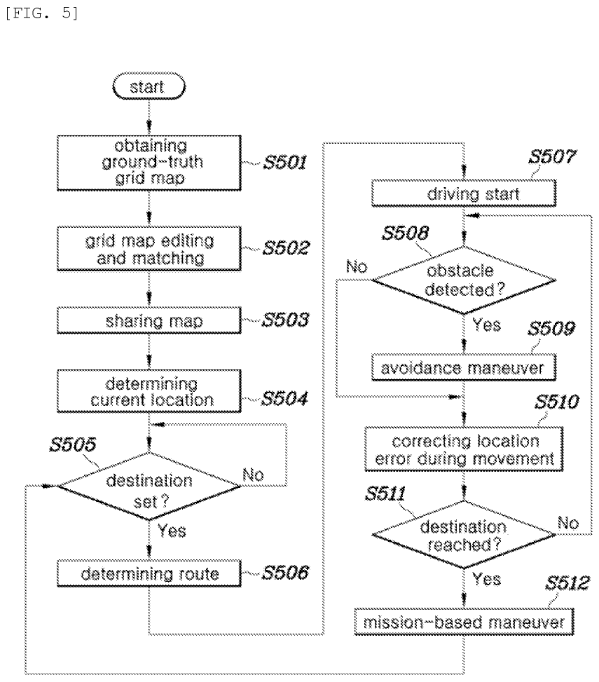

A more detailed configuration of the smart logistics vehicle 110 will be described with reference to FIGS. 3 and 4, and a driving control process of the AMR will be described later with reference to FIG. 5, respectively.

Next, the production equipment 120 may refer to a device (e.g., robot arm, conveyor belt, etc.) that performs a production process of a product in the smart factory 100, and in a broader sense, may refer to a device disposed to assist in performing a mission, such as the entry and exit of the smart logistics vehicle 110 when the production process is performed by a human. A device disposed to assist in performing a mission may refer to devices for detecting the state of a designated location where a pallet carried by the smart logistics vehicle 110 can be dropped off or picked up within an area where a specific production process is performed, devices for determining the progress of the process, and means for blocking entry into the area, but may not be necessarily limited thereto.

For example, the production equipment 120 may be controlled through a programmable logic controller (PLC) and may be capable of communicating with the control device 140 in relation to the process progress.

The monitoring device 130 may perform p a function of obtaining information for determining a situation in the smart factory 100 and transmitting the information to the control device 140. For example, the monitoring device 130 may include a camera, a proximity sensor, and the like, but may not be necessarily limited thereto.

The control device 140 may be capable of obtaining information necessary for operations of the smart factory 100 or controlling each component, by communicating with the aforementioned components 110, 120, 130. For example, the control device 140 may perform deployment, route setting, mission assignment, process management by product, material management, and the like of the smart logistics vehicle 110.

In an implementation, the control device 140 may include a local control device (ACS: AMR/AGV Control System) for controlling surrounding process equipment based on the location of the AGV/AMR and performing mission-based control of the AGV/AMR, and an integrated control device (MoRIMS: Mobile Robot Integrated Monitoring System) for integrating and controlling two or more local control devices. The integrated control device may perform the state and route, logistics flow setting, and traffic control of the entire smart logistics vehicle 110 in the smart factory 100 from each of the plurality of local control devices. For example, when the local control device (ACS) is provided as a unit of smart logistics vehicles of the same manufacturer or model, the integrated control device may perform integrated control for collision prevention, such as analysis of bottleneck levels in intersection/overlapping areas, driving acceleration/deceleration control, and reproduction of avoidance routes, through heterogeneous traffic logistics control on the basis of information obtained through the plurality of local control devices (ACS).

In addition, the integrated control device may also have a manufacturing execution system (MES) as its higher control entity, and the manufacturing execution system (MES) may be interlocked again to an automated scheduler (APS: Advanced Planning & Scheduling).

In addition to the configurations 110, 120, 130, 140 of the smart factory 100 described above, devices for mutual communication between each component, such as beacons, repeaters, and APs (Access Points), chargers for charging smart logistics vehicles 110, loading spaces for storing or loading parts, spaces for storing finished products or intermediate products, traffic lights, circuit breakers, and waiting spaces for idle smart logistics vehicles 110 may be appropriately disposed within the smart factory 100.

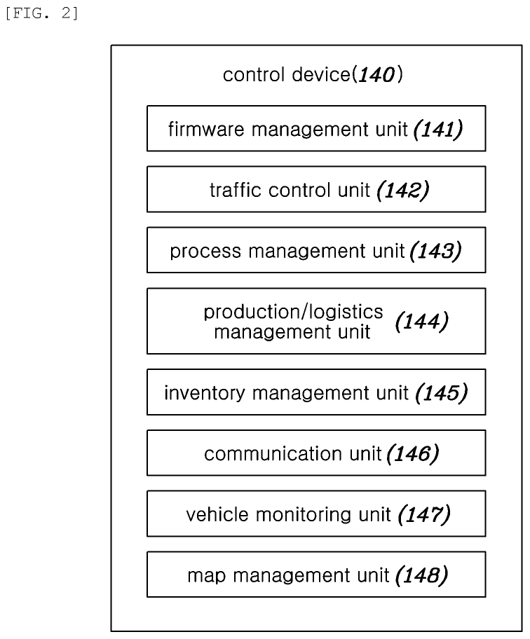

Hereinafter, a configuration of the control device 140 applicable to exemplary embodiments of the present disclosure will be described with reference to FIG. 2.

FIG. 2 is a block diagram showing an example of a control device configuration applicable to exemplary embodiments of the present disclosure. Each component shown in FIG. 2 may mainly represent components related to exemplary embodiments of the present disclosure, and more or less components may be included in the actual implementation of the control device 140.

Referring to FIG. 2, the control device 140 may include a firmware management unit 141, a traffic control unit 142, a process management unit 143, a production/logistics management unit 144, an inventory management unit 145, a communication unit 146, a vehicle monitoring unit 147, and a map management unit 148.

The firmware management unit 141 may obtain the latest firmware of the smart logistics vehicle 110 through the communication unit 146 and transmit the same to the smart logistics vehicle 110 to perform firmware update, thereby maintaining the latest firmware of the smart logistics vehicle 110.

The traffic control unit 142 may control the traffic light and barrier on the basis of the route of the smart logistics vehicle 110, and may recalculate the route of the smart logistics vehicle 110 depending on traffic.

The process management unit 143 may define a process for each product and may manage missions such as a process progress and a progress location.

The production/logistics management unit 144 may deploy the smart logistics vehicle 110 on the basis of mission.

The inventory management unit 145 may manage the location and quantity of each material, and this information may be useful for more efficient process operations, such as departing the smart logistics vehicle 110 to a destination for pallet pickup or retrieval earlier than the time when actual assembly/consumption of materials is detected.

The communication unit 146 may perform communication with internal components of the smart factory 100, such as a smart logistics vehicle 110, a production equipment 120, and a monitoring device 130, as well as external entities, such as a firmware update server.

The vehicle monitoring unit 147 may monitor the location, route, battery state, communication state, power train state, etc. of the individual smart logistics vehicle 110. Herein, the route may be a concept including a waypoint-based global route and a real-time local route. In addition, the battery state may include voltage, current, temperature, peak values of voltage and current, a state of charge (SOC), a state of health (SOH), and the like. The communication state may include information on a currently activated communication protocol (Wi-Fi, etc.), a connected AP, a distance to the AP, a channel in use, and the like. Also, the powertrain state may include a load, temperature, RPM, etc. of the driving system.

In addition, the vehicle monitoring unit 147 may identify the mission, operation mode, firmware version, and the like currently allocated to the individual smart logistics vehicle 110.

The map management unit 148 may obtain map data in the form of a grid map obtained when an AMR among smart logistics vehicles 110 travels inside a smart factory 100, and may provide the obtained map data to a tool for a factory manager to edit. Through the editing of the map data, a zone where one or more preset operations are performed when a smart logistics vehicle 110 enters, a virtual lane, an intersection, a no-entry zone, etc. may be set, but this may be exemplary and not necessarily limited thereto. In addition, the map management unit 148 may distribute the corresponding map through the communication unit 146 to the remaining smart logistics vehicles 110 other than the smart logistics vehicle 110 that obtains the initial grid map through actual driving.

Next, a smart logistics vehicle will be described with reference to FIGS. 3 and 4.

FIG. 3 is a block diagram showing an example of a smart logistics vehicle configuration applicable to exemplary embodiments of the present disclosure.

Referring to FIG. 3, the smart logistics vehicle 110 may include a driving unit 111, a sensing unit 112, a loading unit 113, a communication unit 114, and a controller 115. Hereinafter, each component will be described.

The driving unit 111 may include a driving source, a wheel, a suspension, and the like, which are involved in the movement, steering, and stopping of the smart logistics vehicle 110. The driving source may be an electric motor that receives power from a built-in battery (not shown). The wheels may include one or more driving wheels that receive driving force from the driving source, and non-driving wheels that rotate by the movement of the vehicle body without receiving the driving force. Depending on an implementation, when a plurality of driving wheels are provided, the driving source may be matched for each driving wheel, so that the rotation of each driving wheel may be independently controlled. In this case, by varying the rotation directions of different driving wheels, the steering may be achieved by rotating the vehicle body without a separate steering means. At least some of the non-driving wheels may be configured as caster type wheels, but may be exemplary and may be not limited thereto.

The sensing unit 112 may be for detecting the surrounding environment Of the smart logistics vehicle 100 or its own operating state, and may include at least one of a 2D laser scanner (e.g., LiDAR), a 3D vision (stereo) camera, a multi-axis gyro sensor, an acceleration sensor, a wheel encoder, and a proximity sensor.

The encoder may output information that can determine how much the wheel has rotated by using light emitted from a light-emitting element (e.g., a photodiode). For example, the encoder may count the number of slits disposed along the circumferential direction on the wheel or the disk rotating together with the wheel per unit time. The controller 115 may be capable of performing odometry to estimate displacement by analyzing the amount of location change compared to time with the data obtained from the encoder and gyro sensor. However, the displacement estimated on the basis of the encoder data may have an error from the actual displacement due to wheel slip or wear (The change in the dynamic radius of a wheel). Therefore, when performing odometry, the controller 115 may perform a correction for noise and error on the information collected from the wheel and gyro sensors by using a predetermined algorithm (e.g., EKF: Extended Kalman Filter), thereby outputting a result that tends to be close to the actual value. Such odometry may be particularly useful when current location determination (localization) using a 2D laser scanner, which will be described later, is not possible.

The 2D laser scanner may scan the environment by irradiating the surrounding area with a laser through a rotating reflector and detecting the reflected signal. In this case, by analyzing the intensity of the reflected signal and the time difference between irradiation and reception, the detection result in the form of a point cloud may be outputted.

The 3D vision camera may calculate a distance to an object on the basis of the parallax between two cameras spaced apart as much as a certain distance, that is, the pixel distance between the images captured by each camera. In this case, a texture projector for projecting infrared light of a certain pattern may be provided so that a flat object of the same color (e.g., a white wall) can be detected.

In general, 2D laser scanners may be used for mapping, navigation, object recognition, etc., and 3D cameras may be used especially for obstacle avoidance during navigation, but these may be examples and may be not necessarily limited thereto.

The loading unit 113 is a means for loading target product to be transferred, and may be in the form of a top plate itself on the upper part of the vehicle body, a table disposed on the top plate, a lift, a turntable rotating along a vertical axis, a forklift, a conveyor, or a combination thereof. In the case of a forklift, telescopic and tilting functions may be supported, similar to a forklift.

The communication unit 114 may communicate with other components in the smart factory 100, such as the production equipment 120 and the control device 140, may support communication between the smart logistics vehicles 110, and may communicate with a charger when performing a charging mission.

As an entity that performs overall control of each of the aforementioned components 111, 112, 113, 114, the controller 115 may perform the current mission, current location, destination determination, route planning, loading unit control, etc. on the basis of information obtained from the control device 140 through the communication unit 114.

FIG. 4 is a perspective view showing an example of a smart logistics vehicle exterior applicable to exemplary embodiments of the present disclosure.

Referring to FIG. 4, an example of an AMR is shown as a smart logistics vehicle 110. The vehicle body may have a tracked planar shape with a long axis extending generally along the first axis direction. One driving wheel 111-1 may be disposed in the central part of the vehicle body in the first axis direction, may be disposed at one side in the second axis direction, and the other driving wheel (not shown) may be disposed at the other side to face one driving wheel 111-1 in the second axis direction. Such an arrangement of driving wheels may be referred to as a differential drive (DD). Although not shown in FIG. 4, two or more non-driving wheels may be disposed at a lower part of the vehicle body. In this case, when the two driving wheels rotate in the same direction at the same speed, it may be possible to forward or backward along the first axis direction, and when rotating at the same speed in opposite directions, it may be possible to extend along the third axis direction and rotate on the basis of a rotation axis passing through a plane center (C) of the vehicle body. In addition, the sensor unit 112 may be disposed at the front surface of the vehicle body, and the loading unit 113 may be disposed at the upper surface thereof. The loading unit 113 may be configured to rise and fall along the three-axis direction, and a rack, a tray, and the like may be fixed to the upper surface thereof through a guide 113-1.

However, the AMR form of FIG. 4 described above may be exemplary, and it may be obvious that the AGV has a similar shape or the AMR has a different shape.

Next, a driving process of the smart logistics vehicle 110 will be described with reference to FIG. 5.

FIG. 5 is a flowchart showing an example of a driving process of a smart logistics vehicle applicable to exemplary embodiments of the present disclosure. In FIG. 5, for convenience, it may be assumed that the smart logistics vehicle 110 is an AMR capable of positioning and local route setting.

Referring to FIG. 5, first, the AMR may obtain a ground-truth grid map through a LiDAR or the like while travelling inside the smart factory 100 (S501).

When the *AMR transmits the obtained grid map to the control device 140, a grid map editing and matching process may be performed in the map management unit 148 of the control device 140 (S502). Herein, the editing process may include a process of setting the aforementioned various zones on the aforementioned grid map, a process of assigning costs to each grid, and the like. Herein, the assignment of the cost may be performed in such a way that the closer the AMR is to an obstacle or a no-entry area, the higher the cost is, in order to prevent the AMR from travelling around the obstacle or into an area it should not enter. This is because the AMR selects a set of cells with the lowest cost among waypoints as the route when setting the local route.

In addition, the map matching process may refer to a process of matching coordinates between a CAD map used in the design of a smart factory 100, a ground-truth grid map (LiDAR map), and a topology map that has undergone an editing process.

Thereafter, the control device 140 may share the topology map with all AMRs in the factory through the communication unit 146 (S503).

A subsequent step may be a process applied to an individual AMR.

The AMR may be capable of determining the current location on the map (localization) through sensor data of the sensing unit 112 and the obtained map (S504). For example, the AMR may determine the current location by comparing the surrounding terrain obtained through the LiDAR with the map on the basis of the feature points.

The control device 140 may select a specific AMR and assign a mission and the mission may be assigned one or more waypoints generally determined through global path planning. The waypoint may be defined as coordinates on the map, and may be accompanied by information about the direction (i.e., heading) that the AMR should be heading at the corresponding coordinates. According to the assignment of the mission, a destination may be set in the AMR (Yes in 505), and the AMR may perform local path planning between waypoints on the basis of the cost of the topology map (S506).

When the route is determined, the AMR may start travelling (S507), and when an obstacle is detected through the sensing unit 112 during travelling (Yes of S508), an avoidance maneuver may be performed by performing a local path search for bypassing the detected obstacle (S509). In some cases, the control device 140 may update the mission of the corresponding AMR according to the avoidance maneuver or the failure of the avoidance maneuver.

In addition, the AMR may make corrections for the location error during movement through the aforementioned odometry technique when driving until the destination is reached (S510).

Subsequently, when reaching the destination (S511), the AMR may perform a mission-based maneuver (S512). For example, the AMR may determine whether a condition for entering a specific process area is clear, retrieve an empty pallet from the destination, or drop a load loaded on the loading unit 113.

In an exemplary embodiment of the present disclosure, it may be proposed to improve the process efficiency of the smart factory and increase productivity by checking the possibility of entering a process in advance while the smart logistics vehicle is travelling and by controlling the process accordingly.

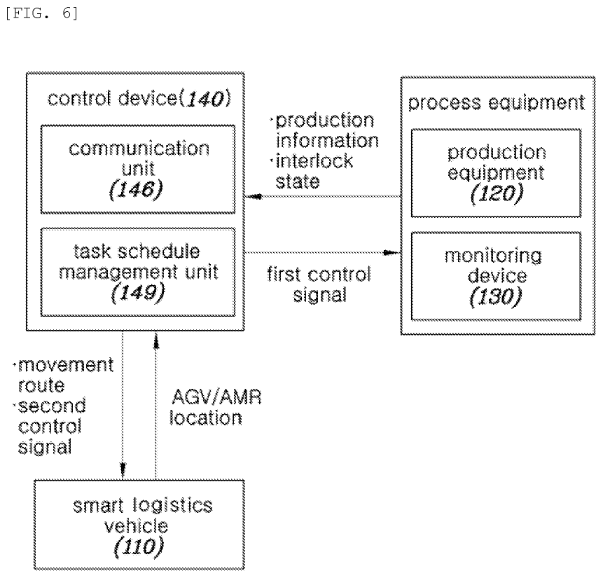

Hereinafter, a smart logistics vehicle according to an exemplary embodiment will be described with reference to FIG. 6.

FIG. 6 is a view for explaining an operation of a control device according to an exemplary embodiment of the present disclosure.

Referring to FIG. 6, the control device 140 of the smart factory according to an exemplary embodiment of the present disclosure may include a communication unit 146 and a task schedule management unit 149, and may have a location, production information, and interlock state of a smart logistics vehicle such as AGV and AMR, as input information.

In addition, the control device 140 may have a movement route, a first control signal, and a second control signal as output information.

Herein, the production information and interlock state may be obtained from process equipment such as the production equipment 120 and the monitoring device 130, and the location of the smart logistics vehicle may be obtained from the communication unit 114 of the smart logistics vehicle 110.

Meanwhile, the control device 140 may determine a movement route on the basis of the input information and transmit the same to the smart logistics vehicle 110, and may control the process by outputting a first control signal for the process equipment or outputting or holding a second control signal for the smart logistics vehicle 110.

Hereinafter, a detailed function of the control device 140 according to an exemplary embodiment will be described.

First, the communication unit 146 may communicate with at least one process controller connected to the production equipment 120. Herein, the process controller may be implemented, for example, as a PLC described above.

The communication unit 146 may continuously exchange the production information, interlock state, first control signal, and the like with the process controller, and transmit the same to the task schedule management unit 149 so that the task schedule management unit 149 may control the production equipment 120, the smart logistics vehicle 110, and the like.

In addition, the communication unit 146 may perform communication with the communication unit 114 of the smart logistics vehicle 110, thereby enabling the task schedule management unit 149 to identify the location of the smart logistics vehicle 110 or control the smart logistics vehicle 110.

Meanwhile, the task schedule management unit 149 may control the communication unit 146 and may determine a movement route of the smart logistics vehicle 110 destined for a specific area on the basis of the inputted production information.

Herein, the production information may include at least one of the operation information of a production robot for a specific area, the production facility information, or the production facility logistics release information.

The operation information of the production robot may include information on whether the robot is operating normally, information on the currently performed operation, and the like, and the production facility information may include detection results obtained through a monitoring device 130, etc. In addition, the production facility logistics release information may include the quantity, type, and current location of the logistics.

Meanwhile, the task schedule management unit 149 may determine whether the smart logistics vehicle 110 is to be deployed for at least one process on the basis of the production information, and may determine a movement route of the smart logistics vehicle destined for a specific area corresponding to the process for which the deployment is determined. For example, a process in which the deployment of the smart logistics vehicle 110 is required or requested may be determined in the light of production information, and the smart logistics vehicle 110 may be deployed to the corresponding process.

In addition, the task schedule management unit 149 may determine whether to deploy by utilizing a memory map stored in advance in order to correspond to the production information.

In addition, the task schedule management unit 149 may output the determined movement route so that the smart logistics vehicle 110 travels along the movement route.

In addition, the task schedule management unit 149 may identify the location of the smart logistics 1 vehicle 110 traveling along the movement route and output the first control signal corresponding to the identified location of the smart logistics vehicle 110 to the process controller corresponding to the specific area. By receiving the first control signal, the process controller may obtain the location of the smart logistics vehicle 110 and reflect the same to determine the production information, interlock information, and the like.

Meanwhile, the first control signal may correspond not only to the location of the smart logistics vehicle 110 but also to the operation state. Herein, the operation state of the smart logistics vehicle 110 may include whether the smart logistics vehicle 110 is docked, whether it is operating normally, what kind of operation it is currently performing, or an expected end time.

Meanwhile, in an exemplary embodiment of the present disclosure, the smart logistics vehicle 110 may include at least one of AMR and AGV.

When *the smart logistics vehicle 110 travelling along the movement route is AMR, the location of the smart logistics vehicle 110 may be identified on the basis of the result of detecting surrounding objects by a sensor connected to the robot.

In addition, when the smart logistics vehicle 110 travelling along the movement route is an automated guided vehicle, it can be identified on the basis of whether nodes disposed apart at multiple points on the movement route pass or not.

In addition, the task schedule management unit 149 can identify the interlock state corresponding to the entry requirements of the specific area from the process controller on the basis of the first control signal outputted during the movement of the smart logistics vehicle 110.

Herein, as a destination of the smart logistics vehicle 110, the specific area may refer to an area where a process to be entered by the smart logistics vehicle 110 is performed.

In addition, the interlock state may correspond to the entry requirements to a specific area, that is, correspond to the entry requirements of the target process, and may be determined by the work progress of the target process, the current work stage, whether it is operating normally, the amount and type of logistics, and the like. In addition, the location of the smart logistics vehicle 110 may be reflected in the interlock state. For example, the current state may not allow the smart logistics vehicle 110 to enter the process, but the estimated arrival time according to the location of the smart logistics vehicle 110 may be reflected in the interlock state, such that the process entry can be allowed.

Meanwhile, the interlock state may be determined by the process controller and transmitted to the task schedule management unit 149 through the communication unit 146.

Meanwhile, the task schedule management unit 149 may output or hold the second control signal for stopping the smart logistics vehicle on the basis of the interlock state. For example, when it is determined that the process entry requirement is met according to the interlock state, the smart logistics vehicle 110 may continue to travel along the movement route by holding the second control signal, and when it is determined that the process entry requirement is not met according to the interlock state, the smart logistics vehicle 110 may stop by outputting the second control signal.

Meanwhile, the task schedule management unit 149 may set an interlock area corresponding to a specific area on the movement route, and may output or hold the second control signal on the basis of the interlock state when the smart logistics vehicle enters the set interlock area. The interlock area may be understood as a space for checking in advance whether process entry is possible before reaching a specific area, and by outputting or holding the second control signal on the basis of the interlock state in the interlock space, it may be possible to ensure that the smart logistics vehicle 110 is not unnecessarily stopped in the process of entering the process, while being allowed to stop when there is a reason such as the impossibility of entering the process.

Meanwhile, the task schedule management unit 149 may determine and output the movement route again when the smart logistics vehicle arrives at a specific area or stops according to the second control signal. That is, the production information, interlock information, and the like may be initialized, and a new control process may be restarted.

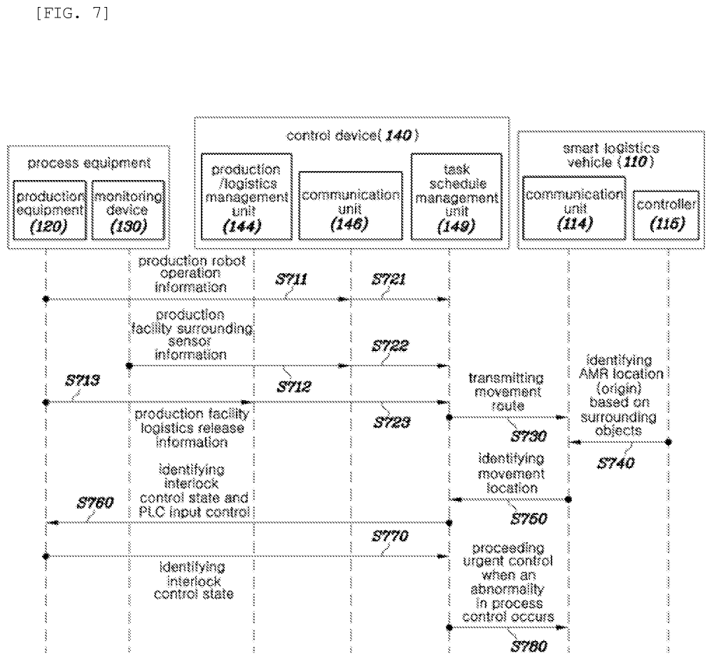

Hereinafter, a control process of the smart factory according to an exemplary embodiment will be described with reference to FIG. 7.

FIG. 7 is a view for explaining a control process according to an exemplary embodiment of the present disclosure.

Referring to FIG. 7, first, the communication unit 146 may receive production robot operation information, production facility surrounding sensor information, production facility logistics release information, and the like from the production equipment 120 and the monitoring device 130. In addition, the production/logistics management unit 144 may receive production facility logistics release information (S711-S713) according to an exemplary embodiment.

Thereafter, the communication unit 146 may transmit the production information to the task schedule management unit 149 (S721-S723), and the task schedule management unit 149 may determine and output the movement route of the smart logistics vehicle 110 on the basis of the production information (S730).

The smart logistics vehicle 110 may travel along the outputted movement route, identify the current location through the controller 115 (S740), and transmit the information to the task schedule management unit 149 so that the task schedule management unit 149 can identify the location of the smart logistics vehicle 110 (S750).

The task schedule management unit 149 may output the first control signal corresponding to the location of the smart logistics vehicle 110 to the process controller so that the process controller may determine and control interlock information (S760), and identify the interlock state from the process controller on the basis of the first control signal (S770).

Thereafter, the task schedule management unit 149 may output or hold the second control signal for stopping the smart logistics vehicle 110 on the basis of the interlock state and the location of the smart logistics vehicle. In this case, when process entry is not possible, such as when an abnormality in the process control is identified depending on the interlock status, a second control signal may be outputted to control the smart logistics vehicle 110 to stop (S780).

By various exemplary embodiments of the present disclosure as described above, it may be possible to reduce process delays that occur when the smart logistics vehicle enters a process, by controlling the process on the basis of a location of the smart logistics vehicle without separate control intervention while the smart logistics vehicle is travelling.

Through this, it may be possible to increase the control convenience of a smart factory and improve process efficiency and productivity.

Although shown and described in connection with a specific exemplary embodiment of the present disclosure as described above, it will be apparent to those skilled in the art that the present disclosure may be variously improved and changed to the extent not departing from the technical idea of the present disclosure provided by the following claims.

### DESCRIPTION OF REFERENCE NUMERALS

100: a smart factory
110: a smart logistics vehicle
120: a production equipment
130: a monitoring device
140: a control device

1. A control method of a smart factory, the method including:
determining a movement route of a smart logistics vehicle destined for a specific area based on an inputted production information and outputting the determined movement route;
identifying a location of the smart logistics vehicle travelling along the movement route and outputting a first control signal corresponding to the identified location of the smart logistics vehicle to a process controller corresponding to the specific area; and
identifying an interlock state corresponding to an entry requirement of the specific area from the process controller based on the outputted first control signal during the movement of the smart logistics vehicle and outputting or holding a second control signal which enables stopping the smart logistics vehicle based on the interlock state.

2. The method of claim 1, wherein the production information includes:
at least one of an operation information of a production robot for the specific area, a production facility information, or a production facility logistics release information.

3. The method of claim 1, wherein the outputting the movement route includes:
determining whether to deploy for at least one process based on the production information; and
determining the movement route of the t smart logistics vehicle destined to the specific area corresponding to the process for which the deployment is determined.

4. The method of claim 3, wherein the determining whether to deploy includes:
determining whether to deploy by utilizing a memory map prestored in order to correspond to the production information.

5. The method of claim 1, wherein the smart logistics vehicle includes:
at least one of an autonomous mobile robot (AMR) and an automated guided vehicle (AGV).

6. The method of claim 5, wherein the location of the smart logistics vehicle is identified based on a result of detecting surrounding objects by a sensor connected to the AMR when the smart logistics vehicle travelling along the movement route is the AMR.

7. The method of claim 5, wherein the location of the smart logistics vehicle is identified based on whether the smart logistics vehicle passes nodes disposed apart at multiple points on the movement route or not when the smart logistics vehicle travelling along the movement route is the AGV.

8. The method of claim 1, wherein the first control signal corresponds to an operation state of the smart logistics vehicle.

9. The method of claim 1, wherein the outputting and holding the second control signal includes:
setting an interlock area corresponding to the specific area on the movement route; and
outputting or holding the second control signal based on the interlock state when the smart logistics vehicle enters the set interlock area.

10. The method of claim 1, wherein when the smart logistics vehicle arrives at the specific area or stops according to the second control signal, a process of the method is returned to the outputting the movement route.

11. A control device of a smart factory, the device including:
a communication unit communicating with at least one process controller; and
a task schedule management unit controlling the communication unit, determining a movement route of a smart logistics vehicle destined for a specific area based on an inputted production information and outputting the determined movement route, identifying a location of the smart logistics vehicle travelling along the movement route, and outputting a first control signal corresponding to the identified location of the smart logistics vehicle to the process controller corresponding to the specific area,
wherein the task schedule management unit identifies an interlock state corresponding to an entry requirement of the specific area from the process controller based on the outputted first control signal during the movement of the smart logistics vehicle and outputs or holds a second control signal which enables stopping the smart logistics vehicle based on the interlock state.

12. The device of claim 11, wherein the production information includes:
at least one of an operation information of a production robot for the specific area, a production facility information, or a production facility logistics release information.

13. The device of claim 11, wherein the task schedule management unit determines whether to deploy for at least one process based on the production information, and determines the movement route of the smart logistics vehicle destined to the specific area corresponding to the process which the deployment is determined.

14. The device of claim 13, wherein the task schedule management unit determines whether to deploy by utilizing a memory map prestored in order to correspond to the production information.

15. The device of claim 11, wherein the smart logistics vehicle includes:
at least one of an autonomous mobile robot (AMR) and an automated guided vehicle (AGV).

16. The device of claim 15, wherein the location of the smart logistics vehicle is identified based on the a result of detecting surrounding objects by a sensor connected to the AMR when the smart logistics vehicle travelling along the movement route is the AMR.

17. The device of claim 15, wherein the location of the smart logistics vehicle is identified based on whether the smart logistics vehicle passes nodes disposed apart at multiple points on the movement route or not when the smart logistics vehicle travelling along the movement route is the AGV.

18. The device of claim 11, wherein the first control signal corresponds to an operation state of the smart logistics vehicle.

19. The device of claim 11, wherein the task schedule management unit sets an interlock area corresponding to the specific area on the movement route and outputs or holds the second control signal based on the interlock state when the smart logistics vehicle enters the set interlock area.

20. The device of claim 11, wherein the task schedule management unit determines and outputs the movement route again when the smart logistics vehicle arrives at the specific area or stops according to the second control signal.
